(19) United States
(12) Patent Application Publication
(10) Pub. No.: US 2014/0189582 A1
(43) Pub. Date: Jul. 3, 2014

(54) DISPLAY CONTROL DEVICE, DISPLAY CONTROL METHOD, AND PROGRAM

(71) Applicant: CANON KABUSHIKI KAISHA, Tokyo (JP)

(72) Inventor: Toshinori Igari, Fuchu-shi (JP)

(21) Appl. No.: 14/141,033

(22) Filed: Dec. 26, 2013

(30) Foreign Application Priority Data
Dec. 28, 2012 (JP) 2012-288232

(51) Int. Cl. G06F 3/0484

(52) U.S. Cl. CPC G06F 3/04845
USPC 715/799

(57) ABSTRACT

A device includes a detecting unit to detect rotation of a display area on a display device, a first deciding unit to decide a first reference point from reference points set in the display area depending on the display position of the displayed object, a specifying unit to specify relative positions of the object based on the display position of the object and the decided first reference point, a second deciding unit to decide the position to arrange the object in the display area after rotation based on the specified relative position of the object and a second reference point corresponding to the first reference point from the reference points set on the display area after rotation in a case where a rotation of the display area is detected, and a control unit to cause a display unit to arrange the object at the decided position.

### BACKGROUND

1. Field

Aspects of the present invention generally relate to a device and method regarding objects in a display area of a display unit.

2. Description of the Related Art

Objects such as icons and windows displayed on a personal computer or other similar display may be arranged in arbitrary positions within the display area of the display by the user to establish the working area.

However, there are cases regarding tablet forms of personal computers in which the display content displayed on the display is rotated when the user rotates the display. For example, when the display is rotated 90 degrees from a landscape view state to a portrait view state, the display content displayed in the display is also changed from landscape to portrait mode, and when rotated another 90 degrees from the landscape view state, the display content displayed in the display changes back to landscape mode.

In such a case, even though an object 153 displayed in a display 151 in the landscape mode as illustrated in FIG. 15A is rotated 90 degrees twice and a display 351 is in the same landscape view state as the display 151 (refer to FIG. 15C), the display content remains at the original coordinates (object 353). However, if an object 152 displayed in the display 151 in the landscape view state is displayed in the same coordinates as on a display 251 in the portrait view state, the object would be positioned as indicated by 254, which is outside of the display area.

Therefore, in order to prevent this from happening, technologies have been proposed to display objects that would be outside the viewing area by moving them into the display area of the display in accordance with changes in the display configuration (Refer to Japanese Patent Laid-Open No. 2008-181522).

According to Japanese Patent Laid-Open No. 2008-181522, when an object is outside the display area due to rotation of the display, the object is simply returned to the display area. Therefore, the object at a coordinate 152 arranged in the corner of the display 151 as illustrated in FIG. 15A is moved, for example, to a coordinate 252 in the display 251 in portrait mode as in FIG. 15B. Then, even when the display is rotated to the state of the display 351, that is to say, to the landscape view state which is the same as that of the display 151 before rotation, the object 352 does not return to a coordinate 354, which is the same as the coordinate 152 before rotation.

### SUMMARY

Aspects of the present invention generally relate to providing a device and method to suitably change the arrangement of objects in accordance with rotation of the display area.

According to the present invention, a display control device includes a detecting unit configured to detect rotation of a display area on a display device that displays objects, a first deciding unit configured to decide a first reference point from a plurality of reference points set in the display area depending on the display position of the object displayed in the display area, a specifying unit configured to specify relative positions of the object based on the display position of the object and the first reference point decided by the first determining unit, a second deciding unit configured to decide the position to arrange the object in the display area after rotation based on the relative position of the object as specified by the specifying unit and a second reference point corresponding to the first reference point from the plurality of reference points set on the display area after rotation in a case where a rotation of the display area is detected by the detecting unit, and a control unit configured to cause a display unit to arrange the object at the position decided by the second deciding unit.

Further features of the present disclosure will become apparent from the following description of exemplary embodiments with reference to the attached drawings.

### BRIEF DESCRIPTION OF THE DRAWINGS

FIG. 1 is a configuration diagram of a display control device according to a first embodiment.

FIG. 2 is a flowchart illustrating a process to arrange objects according to the first embodiment.

FIGS. 3A and 3B are flowcharts illustrating a relative coordinate specifying operation and a flowchart illustrating a process to decide post-modification object coordinates according to the first embodiment.

FIGS. 4A and 4B are schematics describing display control for the display according to the first embodiment.

FIGS. 5A and 5B are schematics describing the display control for the display according to the first embodiment.

FIG. 6 is a schematic describing the display control for the display according to the first embodiment.

FIG. 7 is a flowchart illustrating a processing to arrange objects according to a third embodiment.

FIG. 8 is a schematic describing the display control for the display according to the third embodiment.

FIGS. 9A and 9B are schematics describing the display control for the display according to a fourth embodiment.

FIGS. 10A, 10B, and 10C are schematics describing the display control for the display according to the fourth embodiment.

FIGS. 11A and 11B are schematics describing the display region for the display according to a fifth embodiment.

FIG. 12 is a flowchart illustrating a process to arrange objects according to the fifth embodiment.

FIG. 13 is a schematic describing the display region for the display according to another embodiment.

FIG. 14 is a schematic illustrating an area correspondence table according to another embodiment.

FIGS. 15A, 15B, and 15C are schematics describing a method to rearrange objects according to the related art.

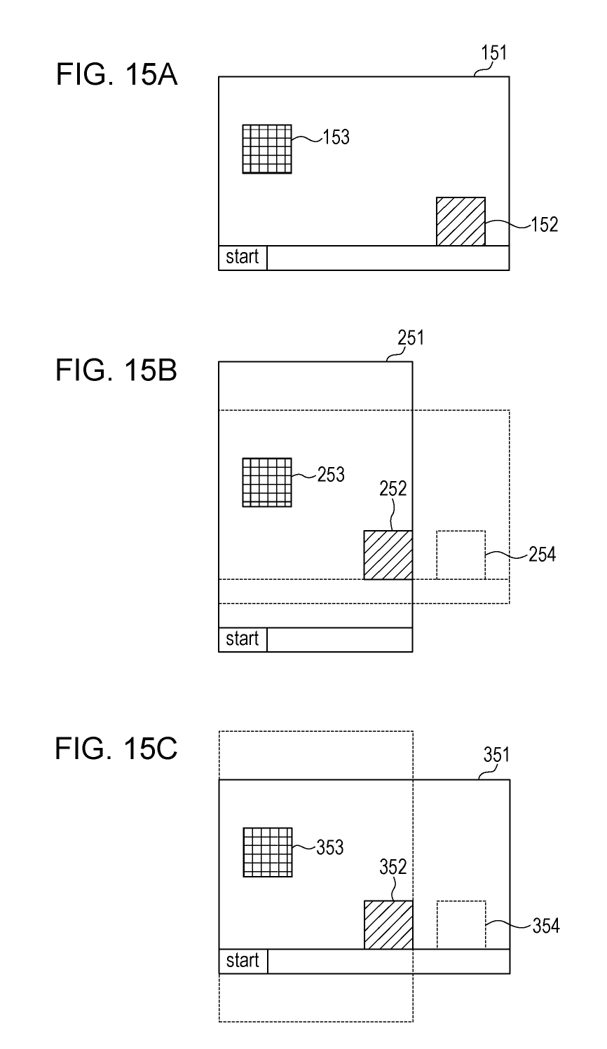

### DESCRIPTION OF THE EMBODIMENTS

Hereafter, exemplary embodiments will be described in detail with reference to the attached drawings. These embodiments are not seen to be limiting, nor is the combination of all of the described characteristics necessarily needed to achieve these embodiments.

### First Embodiment

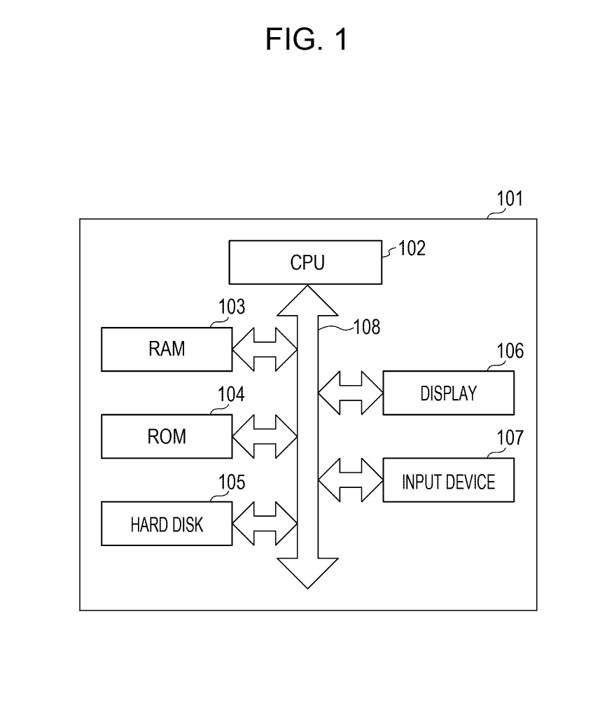

FIG. 1 is a block diagram illustrating a configuration of a display control device 101 according to a first embodiment. The display control device 101 may be a personal computer (PC), smartphone, or other similar device, but is designated as a PC 101 according to the present embodiment.

The PC 101 is provisioned with a CPU 102, a RAM 103, a ROM 104, a hard disk 105, a display 106, and an input device 107, and these components are connected by a system bus 108.

The CPU 102 performs calculations on data and commands, determinations, and controls in accordance with software stored in the RAM 103, the ROM 104, and the hard disk 105.

The RAM 103 is used as a temporary storage area when the CPU 102 is performing various processes such as executing programs. The ROM 104 stores programs such as applications illustrated below that are executed by the CPU 102. The hard disk 105 stores the operating system (OS), application software, and other data.

The display 106 is a display device including a graphics controller and a display device such as a liquid crystal display. Objects such as images and icons, and objects groups of multiple objects such as shortcut menus, launchers, etc., and the graphical user interface (GUI) are displayed in the display area of the display 106.

The input device 107 enables users to input various instructions into the PC 101, and examples of which include mice and touch sensors.

The system bus 108 enables the sending and receiving of data between the CPU 102, the RAM 103, the ROM 104, and the hard disk 105.

According to the present embodiment, the examples will be described using the PC 101 in which the display 106 and the input device 107 are integrated with control units such as the CPU 102 and the RAM 103 as a display control device. However, the display control device according to the present embodiment is not limited thusly. For example, the display control device 101 may be a so-called tablet terminal using touch sensors as pointing devices or a so-called desktop PC in which the display and the input device are separate.

The display 106 according to the present embodiment is provisioned with a gravity sensor, and when the display 106 is rotated by the user, the display content in the display area is also rotated.

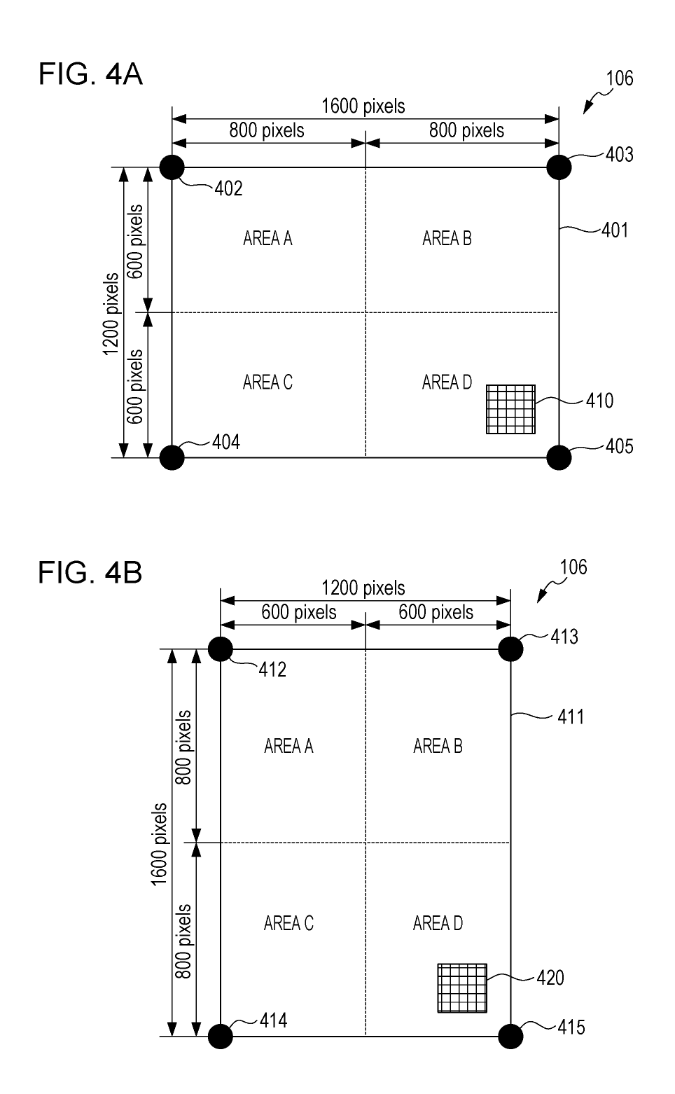

The display of objects in the display 106 will be briefly described using FIGS. 4A and 4B. FIGS. 4A and 4B are schematics describing the display control of the display according to the present embodiment.

The area indicated by 401 as illustrated in FIGS. 4A and 4B is the display area of the display 106, and an object 410 is displayed in this display area 401.

The object 410 is an object such as a character, an icon, or a gadget, or is an object group, which is an aggregate of multiple objects. The object group is a list display of the objects, and examples of which include shortcut menus, launchers, and taskbars for calling various functions and programs. The object 410 in FIGS. 4A and 4B is an object group of multiple objects arranged in quadrangle form, but the shape and number of objects in the object group are not limited thusly. The object 410 may also be a single object.

According to the present embodiment, the size of the display area in the display 106 as illustrated in FIG. 4A is 1200 pixels in height by 1600 pixels in width when the display 106 is arranged in landscape mode. That is to say, the size of the display area when the display 106 is arranged in portrait mode is 1200 pixels in width by 1600 pixels in height as illustrated in FIG. 4B. Though details will be described later, the display area 401 in FIG. 4A is divided into four separate areas (area A, area B, area C, and area D), and the object 410 displayed in the display area 401 is located in area D. According to the present embodiment, the display area 401 is divided into four areas, and the size of each area is 600 pixels in height by 800 pixels in width.

Area reference points 402-405 are located in each area (area A, area B, area C, and area D). According to the present embodiment, the area reference points are rectangular apexes located in each area when the display 106 is rectangular. According to the present embodiment, the upper left of the display area, that is to say, the area reference point 402 is designated as the origin (0, 0), which sets the coordinates for objects. The coordinates of the area reference point 402 are (0, 0), the coordinates of the area reference point 403 are (w₀, 0), the coordinates of the area reference point 404 are (0, h₀), and the coordinates of the area reference point 405 are (w₀, h₀). As the size of the display area in FIG. 4A is 1200 pixels in height by 1600 pixels in width, the coordinates of the area reference point 402 are (0, 0), the coordinates of the area reference point 403 are (1599, 0), the coordinates of the area reference point 404 are (0, 1199), and the coordinates of the area reference point 405 are (1599, 1199).

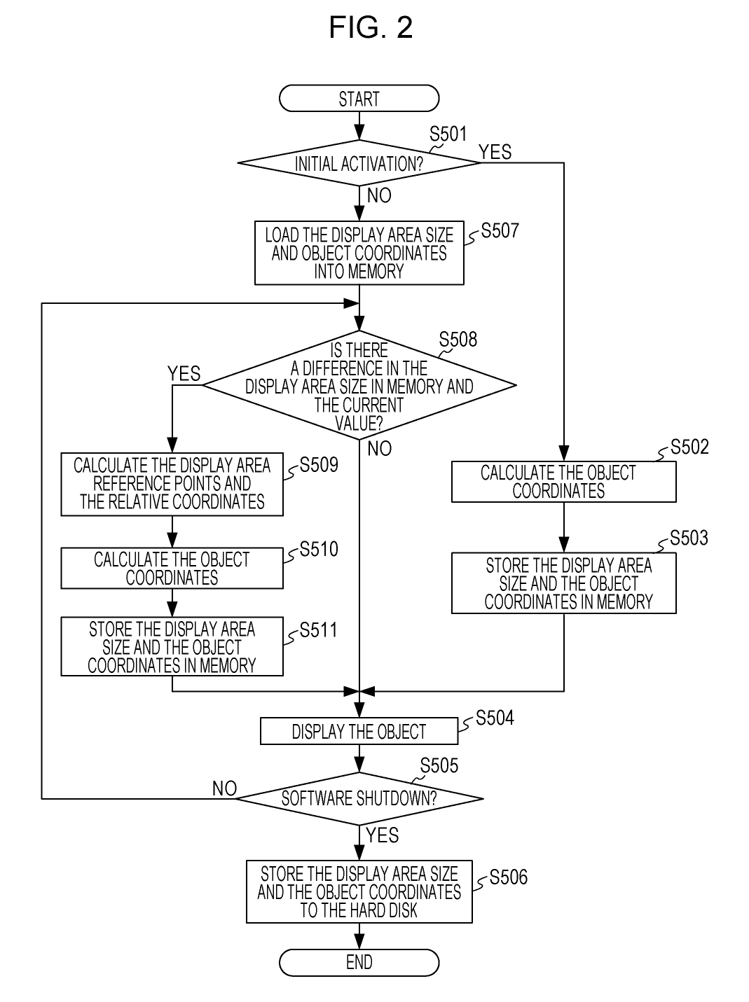

FIG. 2 is a flowchart illustrating a software process of an application operating in the PC 101 according to the present embodiment. That is to say, this flowchart illustrates a software process to control the objects displayed on the display 106 of the PC 101, which is the display control device. The software is executed by the CPU 102.

First, the application is started by an activation instruction from a user instruction or the OS, and the initial activation is determined (S501).

When determined to be initial activation, the standard coordinates is calculated (specified) as the coordinates to display the object in accordance with the size of the display area of the display 106 (S502), and at the same time, the display area size and object coordinates are temporarily stored in the RAM 103 (S503). Then the object is displayed (S504). According to the present embodiment, the initial display coordinates (x₀, y₀) of the object positioned 200 pixels in height and width away from the lower right corner of the display area 401 (area reference point 405 in FIGS. 4A and 4B) are designated as (1399, 999) in S502. According to the present embodiment, the center point of the object 410 is designated as the object reference point (hereafter, referred to as the object coordinates).

When this is not the initial activation, the object coordinates and display area size stored in the hard disk 105 during the previous shutdown are obtained and temporarily stored in the RAM 103 (S507). Then, there is a determination on whether there is a difference between the size of the display area temporarily stored in the RAM 103 and the current display area size (labeled as current value in the drawings) (S508). That is to say, a determination is made at S508 on whether a change in the display area size has been detected. The determination on whether there is a difference in the size of the display area stated here is a comparison of the vertical length and the horizontal length. Therefore, when the length and width of the display area 401 changes in accordance with the rotation of the display 106, for example, there is a determination that the size of the display area is different.

When there is a determination that the obtained object size is not different from the current display area size at S508, that is to say, when the display area size has not changed, the object is displayed at the obtained object coordinates (S504).

When there is a determination that the obtained display area size is different from the current display area size at S508, that is to say, when the display area size has changed, the display area reference point prior to the change (hereafter, referred as a first reference point) and the relative coordinates are calculated (S509).

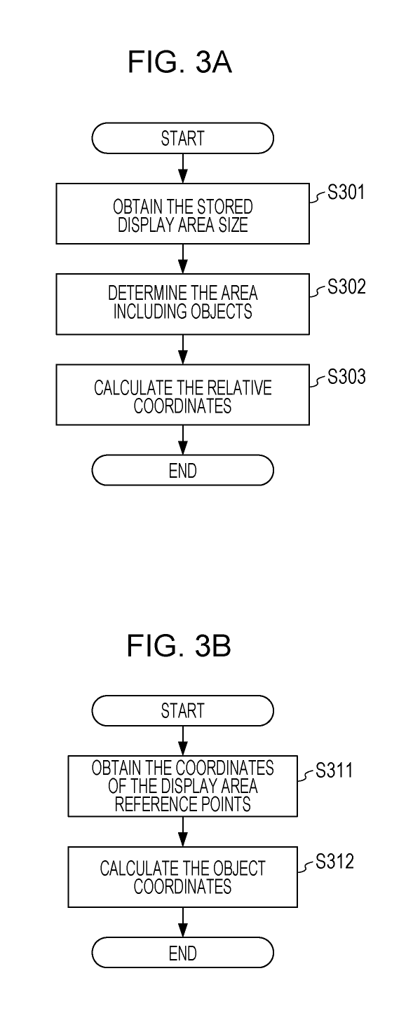

FIGS. 3A and 3B are flowcharts of a relative coordinate specifying operation process according to the present embodiment. During the relative coordinate specific operation process, the CPU 102 operates in the PC 101 to calculate the area reference point and the relative coordinates.

The display area size is rotated 90 degrees from the state illustrated in FIG. 4A in which the height is 1200 pixels (h₀) and the width is 1600 pixels (w₀) to the state illustrated in FIG. 4B in which the height is 1600 pixels (h₁) and the width is 1200 pixels (w₁).

First, the stored display area size is obtained (S301). The display area size of 1200 pixels in height and 1600 pixels in width is obtained here.

Next, the area including the object is determined (S302). According to the present embodiment, a determination is performed as to whether the coordinates for (x₀, y₀) of (1399, 999) are in area A, area B, area C, or area D in the display region 401. The determination of in which area the coordinates (x₀, y₀) are included is made by satisfying any of the following expressions 1-4.

x₀<(w₀/2) and y₀<(h₀/2)

When this Expression 1 is satisfied, the determination is area A.

(w₀/2)≦x₀ and y₀<(h₀/2)

When this Expression 2 is satisfied, the determination is area B.

x₀<(w₀/2) and (h₀/2)≦y₀

When this Expression 3 is satisfied, the determination is area C.

(w₀/2)≦x₀ and (h₀/2)≦y₀

When this Expression 4 is satisfied, the determination is area D.

According to the present embodiment, (1199/2)<x₀ and (1599/2)<y₀ is satisfied, and so area D is the determined area.

The area reference points 402-405 are located in each area as previously described. In FIG. 4A, the coordinates of the area reference point 402 are (0, 0), the coordinates of the area reference point 403 are (1599, 0), the coordinates of the area reference point 404 are (0, 1199), and the coordinates of the area reference point 405 are (1599, 1199). According to the present embodiment, the object is included in area D, and so the area reference point 405 (w₀, h₀) is (1599, 1199), and the display area reference point (first reference point) before the change is (dx₀, dy₀). The relative coordinates of the object are calculated based on the first reference point (area reference point 405) and the object coordinates (1399, 999) (S303).

The relative coordinates (x′, y′) are obtained by the following Expressions 5 and 6.

x′=x₀−dx₀ Expression 5

y′=y₀−dy₀ Expression 6

According to the present embodiment, x′=1399−1599=−200, and y′=999−1199=−200, and so the relative coordinates are (−200, −200).

Returning to FIG. 2, the coordinates to display the object 410 (hereafter, referred to as the object coordinates after the change) in the display area of the display 106 after the change are specified next (S510). According to the present embodiment, the object coordinates are calculated according to the flow illustrated in FIG. 3B. FIG. 3B is a flowchart of a process to decide the object coordinates after the change.

According to the process to decide the object coordinates after the change, the coordinates of the display area reference point after the change (hereafter, referred to as the second area reference point) are obtained first (S311). The second area reference point here is the area reference point after the display area size has changed, and is the area reference point corresponding to the first reference point before the change. According to the present embodiment, the positions of the apexes in the display area before the change (upper-left, lower-left, upper-right, and lower-right) that are the same as the positions of the apexes in the display area after the change (upper-left, lower-left, upper-right, and lower-right) are managed as the corresponding area reference points.

The display area after the change is divided into four equal parts in the same way as the display area before the change, and the areas corresponding to each area in the display area before the change are managed. The coordinates of reference points 412-415, which correspond to the reference points 402-405 in the display 106 after the display area size has changed (after the display is rotated), are (0, 0), (w₁, 0), (0, h₁), and (w₁, h₁). In FIG. 4B, the height is 1600 pixels and the width is 1200 pixels. Therefore, the coordinates of the area reference point 412 are (0,0), the coordinates of the area reference point 413 are (1199, 0), the coordinates of the area reference point 414 are (0, 1599), and the coordinates of the area reference point 415 are (1199, 1599). Therefore, the coordinates (dx₁, dy₁) of the second reference point (area reference point 415) corresponding to the first reference point (area reference point 405) obtained at S509 are (1199, 1599).

Next, the object coordinates after the change (x₁, y₁) is decided based on the object relative coordinates (x′, y′) and the coordinates of the area reference point 415 after the display area size is changed (S312). According to the present embodiment, the object coordinates (x₁, y₁) after the change are decided by the following Expressions 7 and 8.

x₁=dx₁+x′ Expression 7

y₁=dy₁+y′ Expression 8

According to the present embodiment, x₁=1199+(−200)=999, and y₁=1599+(−200)=1399, and so the object coordinates after the change are (999, 1399). As a result, the process to decide the object coordinates is complete.

Returning to FIG. 2, the size of the display area after the change (width: w₁=1200, height: h₁=1600) and the object coordinates (999, 1399) are stored in the RAM 103 (S511), and the object is displayed at the object coordinates (x₁, y₁) (S504).

After the object is displayed at S504, there is a determination on whether or not the software has shutdown (S505).

If the software is still running, the process returns to S508, determines whether there is a change in the display area size of the display, and if the software has quit, the process proceeds to S506, stores the current object coordinates to the hard disk 105, and the process then completes.

Returning to S508, we will now describe when the display area of the display 106 is rotated another 90 degrees to the right to return to the landscape view state after the first rotation from the landscape view illustrated in FIG. 4A to the portrait view illustrated in FIG. 4B. In this case, the steps of S509 through S511 are repeated.

At S509, the display area size (height of 1200 pixels, width of 1600 pixels) is obtained from the hard disk 105 (S301). Then, the object coordinates are (999, 1399), and as (1599/2)<x₀ and (1199/2)<y₀ is true, the object is determined to be in area D similar to the first rotation of 90 degrees (S302). In the case of FIG. 4B, the coordinates of the area reference point 412 are (0, 0), the coordinates of the area reference point 413 are (1199, 0), the coordinates of the area reference point 414 area (0, 1599), and the coordinates of the area reference point 415 are (1199, 1599). The object is included in area D, and so the area reference point 415 (w₀, h₀)=(1199, 1599) is the first reference point (dx₀, dy₀). Thus, x′=999−1199=−200 and y′=1399−1599=−200, and so the relative coordinates of the object are (−200, −200) (S303).

Next, in S510 the coordinates of the second reference point are obtained first (S311). The display area of the display 106 after the display area size has changed (after the display has been rotated) is 1600 pixels in height and 1200 pixels in width. Therefore, the coordinates of the area reference points 402-405 corresponding to the area reference points 412-415 are (0, 0), (1599, 0), (0, 1199), and (1599, 1199), respectively. Therefore, the coordinates (dx₁, dy₁) of the second reference point (area reference point 405) corresponding to the first reference point (area reference point 415) obtained at S509 are (1599, 1199).

Therefore, as x₁=1599+(−200)=1399 and y₁=1199+(−200)=999, the object coordinates after the change (x₁, y₁) are (1399, 999).

According to the present embodiment, when the display area is rotated to the right 90 degrees two times, it is possible to display the object at the same coordinates displayed in the display area 401 before the rotation.

According to the present embodiment and as previously described, the first reference point is decided from the object coordinates in the display area 401 of the display 106, and the relative coordinates of the object in the area are calculated using the first reference point, which is then preemptively stored. Then the object is displayed in the same area at the position in the display area after the size change (after the display is rotated) away from the second reference point by the amount of the relative coordinates that has been saved. As a result, when the rotation of the display area in the display 106 is repeated, variances in the position of the object in the display area may be suppressed. That is to say, the user may arrange the object in the intended position even after rotating the display 106 (rotating the display area).

### Second Embodiment

The present embodiment is similar to the first embodiment except for S303 of the method to specify the relative coordinates and S312 of the method to specify the object coordinates, and so any redundant descriptions are omitted.

According to the first embodiment, the relative coordinates in the area where the object is located is calculated based on the difference between the coordinates of the object and the first reference point, that is to say, the distance from the object to the first reference point. Then, the object coordinates after the change are decided using the calculated relative coordinates so that the object is positioned a predetermined distance from the second reference point. In contrast according to the present embodiment, the relative coordinates of the object are calculated based on the distance ratio between the first reference point in the display area and the object display position.

Then, the object coordinates after the change are decided using the relative coordinates of the object so that the distance ratio between the second reference position in the display area and the display position of the object is the same as the distance ratio between the first reference point in the display area and the display position of the object. That is to say, the relative coordinates of the object are calculated based on the ratio of the length in the vertical direction of the distance in the display area from the first reference point to the object coordinates and the ratio of the length in the horizontal direction of the distance in the display area from the first reference point to the object coordinates.

Then, the object coordinates after the change are decided so that the calculated relative coordinates of the object are in a position of a predetermined ratio from the second reference point regarding the length in the vertical direction in the display area and a position of a predetermined ratio from the second reference point regarding the length in the horizontal direction in the display area. Specifically, the relative coordinates of the object (x′, y′) may be calculated with the following Expressions 9 and 10 instead of the Expressions 5 and 6, and the object coordinates (x₁, y₁) may be calculated with the following Expressions 11 and 12 instead of the Expressions 7 and 8. The user may still arrange the object in the intended position after rotating the display 106 similar to the first embodiment by this method as well. For example, the object coordinates after the display is rotated 90 degrees two times may be the same as the object coordinates before the rotation.

X′=(x₀−dx₀)/w₀ Expression 9

y′=(y₀−dy₀)/h₀ Expression 10

x₁=dx₁+x′×w₁ Expression 11

y₁=dy₁+y′×h₁ Expression 12

The description will use the example as illustrated in FIG. 4A, in which the object is located in area D, the first reference point is the area reference point 405 (1599, 1199), and the object coordinates are (1399, 999). When the display is rotated 90 degrees, the relative coordinates of the object (x′, y′) are (−0.125, −0.167) from calculating x′=(x₀−dx₀)/w₀ ((1399-1599)/1600=−0.125) and y′=(y₀−dy₀)/h₀ ((999-1199)/1200=−0.167). The object coordinates after the change (x₁, y₁) are (1049, 1332) from calculating x₁=dx₁+x′×w₁=1199+(−0.125)×1200=1049) and y₁=dy₁+y′×h₁=1599+(−0.167)×1600=1332.

Similar to the first embodiment, when the display is rotated to the right another 90 degrees from this state, the object is determined to be in area D, and the second reference point is the area reference point 405 (1599, 1199). In this case, the relative coordinates of the object in the area are (−0.125, −0.167) from calculating x′=(x₀−dx₀)/w₀ ((1049−1199)/1200=−0.125) and y′=(y₀−dy₀)/h₀ ((1332−1599)/1600=−0.167). The object coordinates after the change (x₁, y₁) are (1399, 999) from calculating x₁=dx₁+x′×w₁ (1599+(−0.125)×1600=1399) and y₁=dy₁+y′×h₁=1199+(−0.167)×1200=999.

According to the present embodiment and similar to the first embodiment, the first reference point is decided from the object coordinates in the display area 401 of the display 106, and the relative coordinates of the object in the area D are calculated using the first reference point, which is then preemptively stored. Then the object is displayed in the same area D at the position in the display area after the change (after the display is rotated) away from the second reference point by the amount of the relative coordinates. As a result, when the rotation of the display area in the display 106 is repeated, variances in the position of the object in the display area may be suppressed. That is to say, the user may arrange the object in the intended position even after rotating the display 106 (rotating the display area).

Also according to the present embodiment, the relative position of the object coordinates and the object coordinates after the change are obtained using the length in the vertical direction and the length in the horizontal direction of the display area, but this is not limited thusly. For example, the length in the vertical direction and the length in the horizontal direction of the area where the object is present may be used instead of the length in the vertical direction and the length in the horizontal direction of the display area.

### Third Embodiment

The present embodiment is similar to the first embodiment, specifically the configuration of the display control device 101 and the configuration of the software that operates on the display control device 101, except for the method to control the display of the object on the display 106, and so any redundant descriptions are omitted.

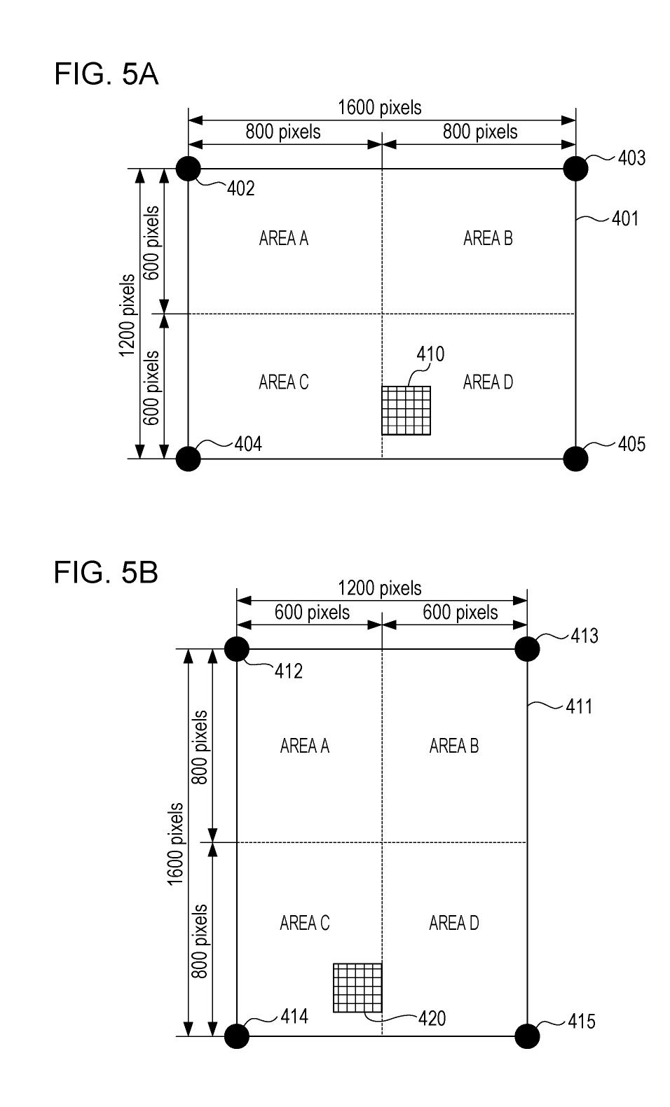

According to the first embodiment, variance in the positions of objects may be suppressed when the display is repeatedly rotated. However, there are cases in which the object does not return to the original coordinates when the display 106 is repeatedly rotated 90 degrees depending on the position where the object is located in the display 106. As illustrated in FIG. 5A, for example, when the coordinates (x₀, y₀) of the object 410 in the display area 401 of the display 106 are (899, 999), the first part of the process determines that the object is located in area D at S509, which is the same as for the first embodiment. As a result, the relative coordinates (x′, y′) are (−700, −200) from calculating x′=x₀−dx₀=899−1599=−700 and y′=y₀−dy₀=999−1199=−200.

Afterwards, the object coordinates (x₁, y₁) in the display area 411 after the display area is rotated 90 degrees are decided at S510. As illustrated in FIG. 5B, the coordinates of an object 420 (x₁, y₁) at this time are (499, 1399) from calculating x₁=dx₁+x′=1199+(−700)=499 and y₁=dy₁+y′=1599+(−200)=1399.

l_{iεR}ε{obj,bkg}

When the display area 411 is rotated another 90 degrees from the state illustrated in FIG. 5B, the determination of which area the object of S302 is located in S509 changes from area D to area C. As a result, an area reference point 514, (dx₀, dy₀)=(0, 1599), is selected as the first reference point. As a result, the relative coordinates (x′, y′) are (499, −200) from calculating x′=x₀−dx₀=499−0=499 and y′=y₀−dy₀=1399−1599=−200.

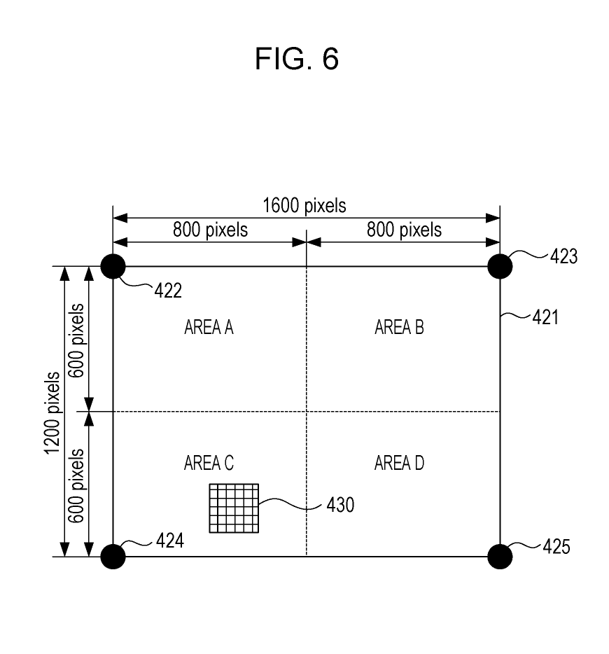

The coordinates of an object 430 (x₁, y₁) in the display area 421 after being rotated 90 degrees are present in area C at S510 as illustrated in FIG. 6. Specifically, the coordinates of the object 430 (x₁, y₁) are (499, 999) from calculating x₁=dx₁+x′=0+499=499 and y₁=dy₁+y′=1199+(−200)=999, which is different from the coordinates of the object 410 before the rotation (899, 999).

Thus, according to the first embodiment, when the object is present near the boundaries of the divided area, there may be variances in the position of the object when the display is repeatedly rotated. According to the present embodiment and in response to this, an area determination is performed for the object, the area ID is set, and additionally, the area determination is repeated when the object is moved due to user operation. As a result, the object may be arranged in a suitable position after the size of the display area changes due to the rotation of the display 106.

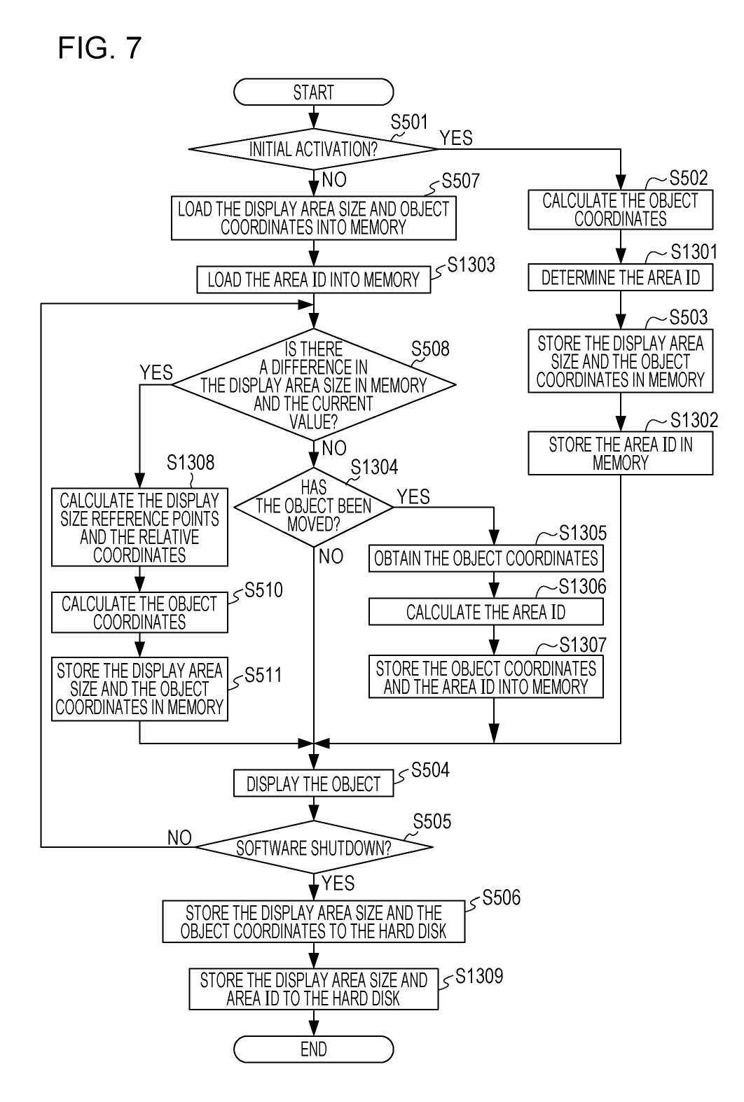

FIG. 7 is a flowchart of a process to arrange the object according to the present embodiment. The parts of the process that the same as that in the flowchart described with FIGS. 3A and 3B have the same reference numerals, and their detailed descriptions are omitted.

First, whether this is initial activation or not is determined (S501).

When determined to be initial activation, the object coordinates in the display area are calculated (specified) (S502), and the area ID is decided (S1301). The method to decide the area ID will be briefly described here using FIGS. 5A and 5B. Similar to S509 of the first embodiment, the display area 401 is divided into four areas A-D, and a determination is made regarding in which area the object 410 is present. The name of the area in which the object 410 is present is the area ID. That is to say, the area name (area D according to the present embodiment) in which the object 410 is present is decided as the area ID at S1301. The display area size and the object coordinates are then stored in memory (S503), and the decided area ID is temporarily stored in the RAM 103 (S1302).

If not initial activation, the display area size and the object coordinates stored in the hard disk 105 are obtained and stored in the RAM 103 (S507), and the area ID stored in the hard disk 105 is obtained and stored in the RAM 103 (S1303). Then the process proceeds to S508.

At S508, a determination is made on whether or not the stored display area size is different to the current display area size (current value). That is to say, at S508, a determination is made on whether or not a change in the display area size has been detected.

When the stored display area size is determined to be different than the current display area size at S508, the first reference point and the relative coordinates are calculated (S1308). According to the first embodiment, the area is determined using Expressions 1 through 4, but according to the present embodiment, the area ID temporarily stored in the RAM 103 is used instead of performing the area determination. Other than this, the process is the same as for S509 of the first embodiment, and so such description is omitted. Afterwards, the process proceeds from S1308 to S510 and S511, and as S510 and S511 here are the same as that for the first embodiment, such description is omitted.

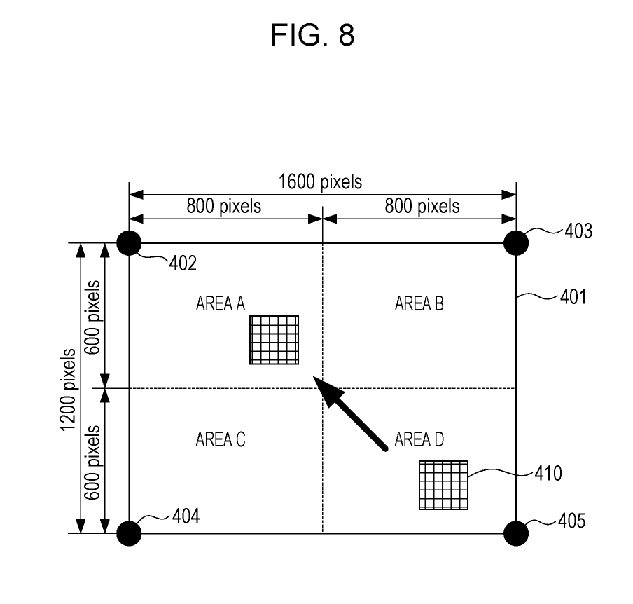

When the size of the display area stored in S508 is determined to be the same as the current display area size, a confirmation is made on whether or not the object has been moved due to user operation (movement detection) (S1304). The user operation here refers to a user instruction via the input device 107 such as a mouse or touch sensor. When the object has not been moved, the process proceeds to S504. When the object has been moved, the object coordinates are obtained (S1305), and the area ID is calculated (S1306). Then, the object coordinates and the area ID are updated by being stored in the RAM 103 (S1307). As illustrated in FIG. 8, for example, when the object 410 is moved from area D to area A by user operation, the value of the area ID stored in the RAM 103 is updated to area A. Afterwards, the process proceeds to S504.

The present embodiment will be described using a case in which the display 106 is rotated 90 degrees to the right two times causing the display area to be rotated 90 degrees to the right two times.

First, at S508 after the display is rotated 90 degrees to the right two times, when a determination is made that the stored display area size is different from the current display area size, and the process proceeds to S1308, the object is designated to be present in the set area ID, that is to say, area D. Therefore, when the relative coordinates are calculated, the area reference point 415 (dx₀, dy₀)=(1199, 1599) is used as the first reference point. Thus, the relative coordinates (x′, y′) are (−700, −200) from calculating x′=x₀−dx₀=499−1199=−700 and y′=y₀−dy₀=1399−1599=−200.

Then, the object coordinates (x₁, y₁) regarding the display that has been rotated 90 degrees to the right two times are decided using the area reference point 405 (dx₁, dy₁)=(1599, 1199) for area D as the second reference point. Specifically, the object coordinates (x₁, y₁) are found to be (899, 999) from calculating x₁=dx₁+x′=1599+(−700)=899 and y₁=dy₁+y′=1199+(−200)=999. This matches the coordinates of the object 410 before the rotation.

When the object is moved due to user operation after the display area is rotated, the size of the stored display area and the current display area size are different at S508, and so the process proceeds through S1308, S510, S511, and S504 to S505. Then, the process returns to S508, proceeds to S1304, the object coordinates are obtained at S1305, the area ID is calculated at S1306, and the object coordinates and the area ID are stored in memory at S1307.

According to the present embodiment, the relative position of the object in the display area does not change when the display 106 is repeatedly rotated and so may be arranged in a suitable position. That is to say, the object may be arranged in a suitable position as intended by the user. This is particularly advantageous when the object is located near the boundary of the divided area.

According to the present embodiment, when the object is moved due to user operation, the area ID is updated (S1307). As a result, when the object is moved as the user intends, and the display is rotated after this movement, the object may be displayed in a position relative corresponding to the coordinates of the object after being moved due to user operation.

After the first reference point corresponding to the object is set and the first reference point is not updated (does not change), it is disadvantageous when the object area moves due to user operation. Specifically, when the user wants to place the object 410 in FIG. 5A in the upper-right corner of the display 106 and moves the object into area B, and as the first reference point is still 1005 in area D, the object does not return to the original coordinates when the display is repeatedly rotated. To prevent this according to the present embodiment, the first reference point is updated when the user manually moves the object via a mouse or other operation. As a result, the object after rotation may be arranged in a suitable position, and the movement of the object due to user operation may be reflected.

### Fourth Embodiment

The present embodiment is similar to the first embodiment, specifically the configuration of the display control device 101 and the configuration of the software that operates on the display control device 101, except for the method to control the display of the object displayed on the display 106, and so any redundant descriptions are omitted.

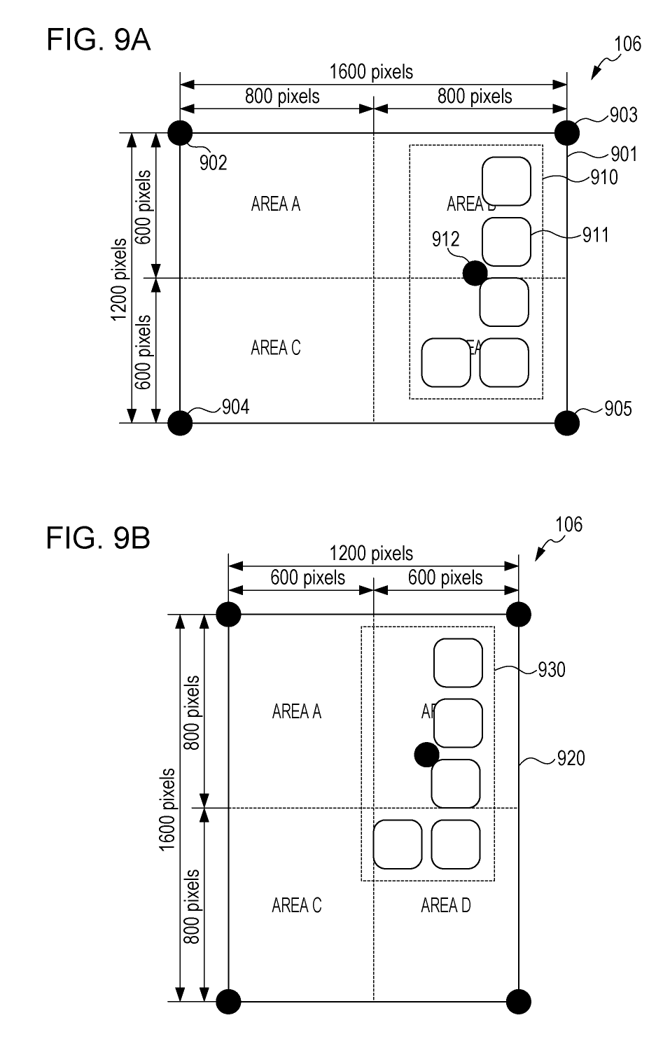

FIGS. 9A and 9B are schematics describing a method to control the display of objects according to the present embodiment. As illustrated in FIG. 9A, an object 910 is an object group including multiple elements (multiple objects) 911. According to the present embodiment, this kind of object group is managed as one object 910 to perform the display control.

When the display control method according the first embodiment and the second embodiment is applied, there are cases when the object may not be arranged in the desired position when the display 106 is rotated depending on the form and size of the object 910. As illustrated in FIG. 9A, for example, a rectangular center 912 enclosing the object is designated as the object coordinates, and the corner of an L-shaped object 910 is desired to be arranged near the corner of a display area 901. As illustrated in FIG. 9A, when the corner of the object 910 is arranged near the lower-right corner of the display area 901, and the center 912 of the object 910 is located in area B, the first reference point is 903. Therefore, when the display 106 is rotated 90 degrees to the right, the object 910 deviates from the lower-right corner of a display area 920 as illustrated in FIG. 9B.

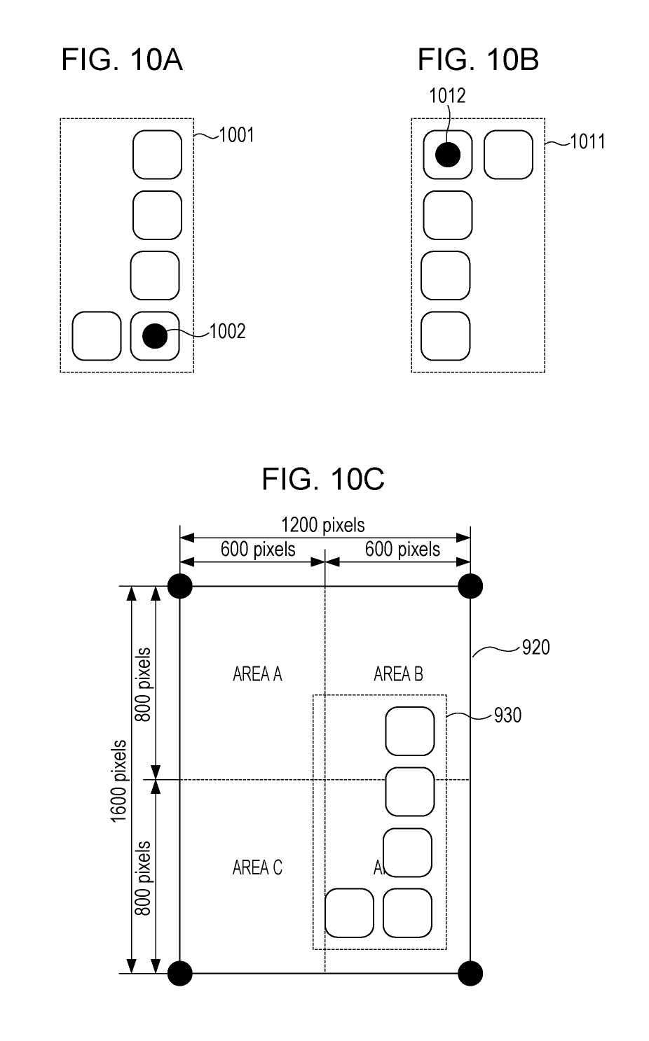

According to the present embodiment, the coordinates of the object 910 are set at the apex of the corner of the L-shaped object 910 in FIG. 9A instead of the object coordinates of the center of the object, as is the case with the first embodiment and the second embodiment. As a result, when the display area 901 from FIG. 9A is rotated 90 degrees to the right, the apex of the corner of the L-shaped object 930 may be arranged at coordinates near the corners of area D in the display area 920 as illustrated in FIG. 10C.

That is to say, when a predetermined portion of the object is desired to be arranged in a predetermined position in the display area, the predetermined portion of the object (for example, the apex of the corner of the L-shaped object 910 in FIG. 9A) are set as the object coordinates instead of the center of the object.

An object of the same size as the object 910 in FIGS. 9A and 9B will be used as the example for the description, and so when the apexes of the corners of the L-shaped object are desired to be arranged in a predetermined position, the apexes (1002 and 1012) of the corners of the L shape are set as the object coordinates as illustrated in FIGS. 10A and 10B.

According to the present embodiment, a predetermined portion of the object may be arranged at a predetermined position in the display area. That is to say, the object may be arranged at a predetermined position even when the display area changes due to rotation of the display 106.

According to the present embodiment, this is applicable even when the longitudinal width and/or the transverse width of the object are significant regarding the longitudinal width and/or transverse width of the display. When the object is significant in size, and the center of the object is set as the object coordinates, there are cases in which the object may not be displayed in the display area when the display area changes. According to the present embodiment, a situation where the object is not displayed in the display area is prevented by, for example, arranging the coordinates of the corners of the object so as to be situated at predetermined positions in the display area.

The setting of the object coordinates may be set by the user, or may be automatically set by the application depending on the form, size, or other characteristics. When automatically set by the application, for example, the object coordinates may be set to the nearest position from area reference point closest to the object.

### Fifth Embodiment

The present embodiment is similar to the first embodiment, specifically the configuration of the display control device 101 except for the method to control the display of the object on the display 106, and so any redundant descriptions are omitted.

The example used as the change in the display size of the display area to describe the first through fourth embodiments has been a rotation of the display area, but the example used for the present embodiment is a change in the resolution of the display area.

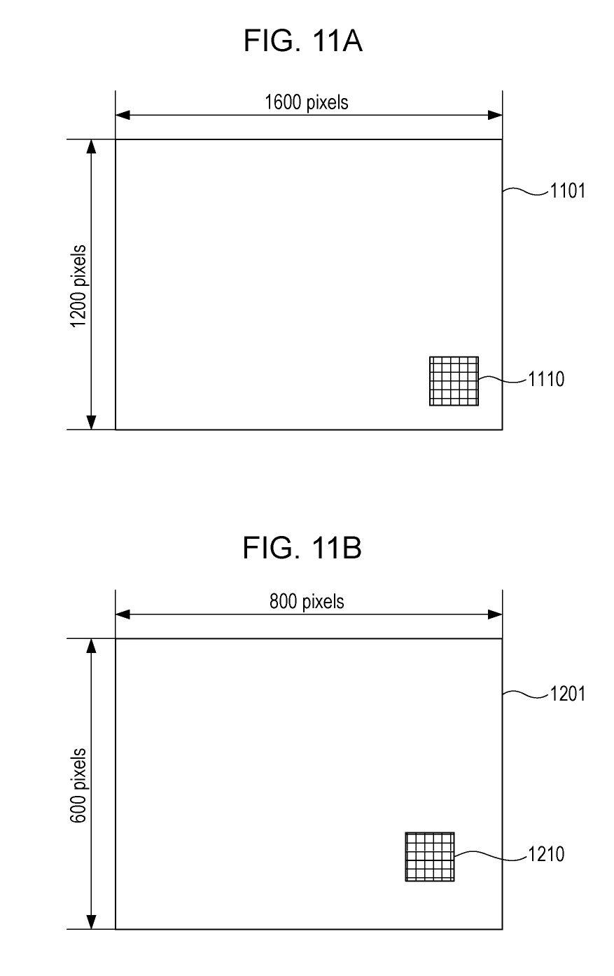

When the resolution of the same display area is changed, and the object coordinates after the change are decided using the relative coordinates which are calculated based on the difference between the first reference point and the object coordinates (distance between the first reference point and the object coordinates), the relative position of the object in the display area changes. For example, when the resolution is lowered from 1200 pixels in height by 1600 pixels in width as illustrated in FIG. 11A to 600 pixels in height by 800 pixels in width as illustrated in FIG. 11B, the object is moved to the center of the display area.

According to the present embodiment, a determination is made on whether the number of pixels regarding the height/width of the display shifted before and after this change, and when the value of the height/width has not shifted, the object is arranged in the display after the change in accordance with a ratio of the number of pixels before and after the change.

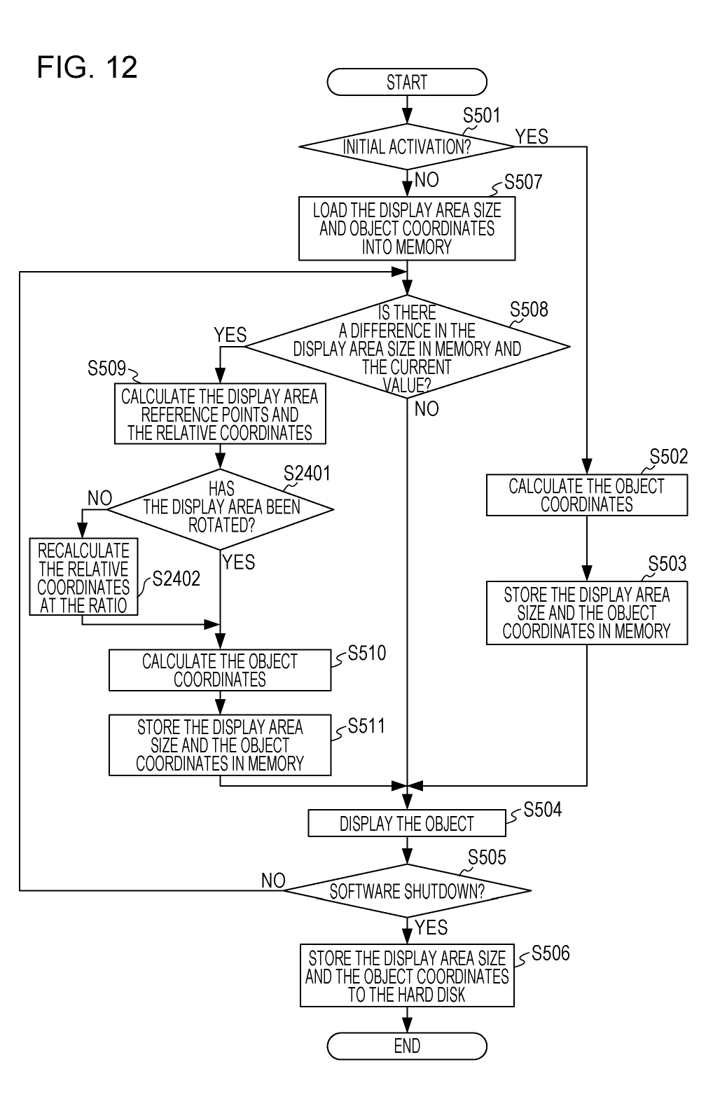

FIG. 12 is a flowchart illustrating a software process according to the present embodiment. This software is executed by the CPU 102. The parts of the process that are the same as the software flow regarding the first embodiment illustrated in FIG. 2 have the same reference numerals, and such description is omitted.

According to the present embodiment, the display area reference point (the first reference point) is obtained at S509, and then a determination is made on whether the display has been rotated after calculating the relative coordinates based on the first reference point (S2401). Specifically, the number of pixels in the horizontal direction and the vertical direction of the display before the change are designated as Px₀ and Px_{y}, and the number of pixels in the horizontal direction and the vertical direction of the display after the change are designated as Px₁ and Py₁, and so the determination that the display rotated is made when Px₀ and Py₁ match and Px₁ and Py₀ match.

When the determination that the display has rotated is made, the process proceeds to S510, and the object coordinates are calculated.

When the determination that the display has not rotated (that is to say, when the display is not rotating), the process proceeds to S2402, and the following expression is used to calculate relative coordinates (x″, y″) based on the relative coordinates (x′, y′) obtained at S509. That is to say, when the display area size in memory and the current values are different, and the display area is not rotating, the relative coordinates are decided again at S2402. The method to calculate x′ and y′ may use either method described regarding the first and second embodiments. The process then proceeds to S510.

x″=x′×Px₁/Px₀ Expression 13

y″=y′×Py₁/Py₀ Expression 14

As a result, when the resolution changes from 1600 pixels in width by 1200 pixels in height as illustrated in FIG. 11A to 800 pixels in width by 600 pixels in height as illustrated in FIG. 11B, the x coordinate (x″) and the y coordinate (y″) are half of the original x coordinate (x′) and the y coordinate (y′). Therefore, the relative position of the object in the display area may not be changed when deciding the object position.

According to the present embodiment, the predetermined position of the object may be arranged in a predetermined position in the display area even when the resolution of the display is changed. That is to say, the object may be arranged in the position in the display area intended by the user.

According to the present embodiment, the determination on whether the display area has rotated is made at S2401 after calculating the first reference point and the relative coordinates at S509, but of course the determination on whether the display area has rotated may be made before calculating the relative coordinates. In this case, the relative coordinates after the change in resolution may be calculated based on the first reference point without re-deciding the relative coordinates.

Though not illustrated, a case in which both a change in resolution in the display area and a rotation of the display area occur simultaneously will be briefly explained. In this case, the object coordinates may be decided by performing the process to decide the object coordinates regarding a change in the resolution of the display area followed by performing the process to decide the object coordinates regarding a rotation using these decided object coordinates. Alternatively, the object coordinates may be decides by performing the process to decide the object coordinates regarding a rotation in the display area followed by performing the process to decide the object coordinates regarding a change in the resolution of the display area using these decided coordinates.

### Other Embodiments

While exemplary embodiments have been described, the basic configuration of the present disclosure is not limited thusly. The examples regarding the previously described embodiment used a case in which one object was displayed in the display area, and cases of multiple objects are similar. That is to say, when there are multiple objects, a display control similar to that of the previously described embodiments may be performed on each object.

According to the previously described embodiments, the object coordinates are arranged in positions away from the area reference points, but they may be arranged so as to match the area reference points. The object coordinates may be decided after the change in this case as well, which is similar to that of the previously described embodiments.

The previously described embodiments have been described using a case in which the rotation of the display area is caused by the rotation of the display 106, but the present disclosure may also be applied when the display area is rotated due to some other reason. The previously described embodiments have been described using a case in which rotations in the display area are specified by a gravity sensor, but the present disclosure is not limited thusly, and this may also be specified, for example, by the input of information on the rotation of the display area.

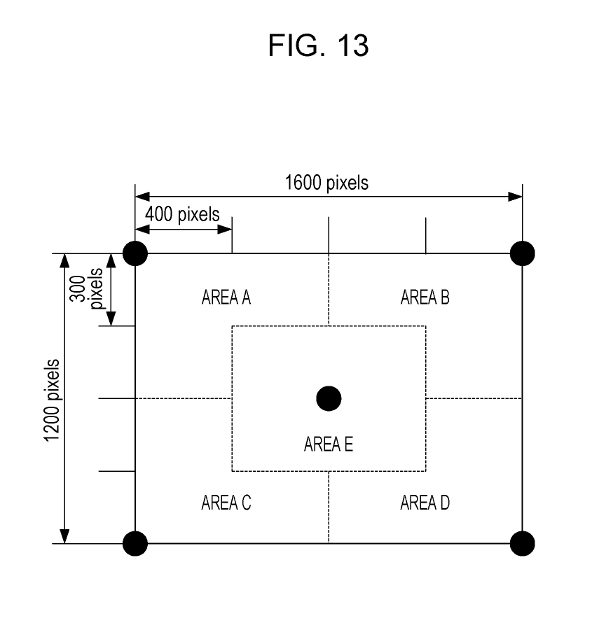

According to the previously described embodiments, the display area of the display 106 is divided into four equal parts set as areas A-D, but the present disclosure is not limited thusly, the number of areas may be three or less, or five or more, the size of each area may be different, and the shape of the areas may also be different. As illustrated in FIG. 13, for example, the display area may be divided into five areas A-E having different rectangular shapes. When dividing the display area as illustrated in FIG. 13, the area reference point of area E may be the center of area E, for example.

According to the previously described embodiments, the corners of each area that corresponded with the corners of the display 106 are designated as the area reference point of each area, but the present disclosure is not limited thusly. That is to say, the area reference points of the display area may be set as desired. For example, the area reference point of each area may be set to the center of each area as with area E in FIG. 13, then when the object is near the center of the display area, the corners of each area toward the center may be designated as the area reference points, and then when the object is near the corners of the display area, the corners of the display area may be designated as the area reference points. In either case, the object may be moved with the area reference point of each area as the first reference point.

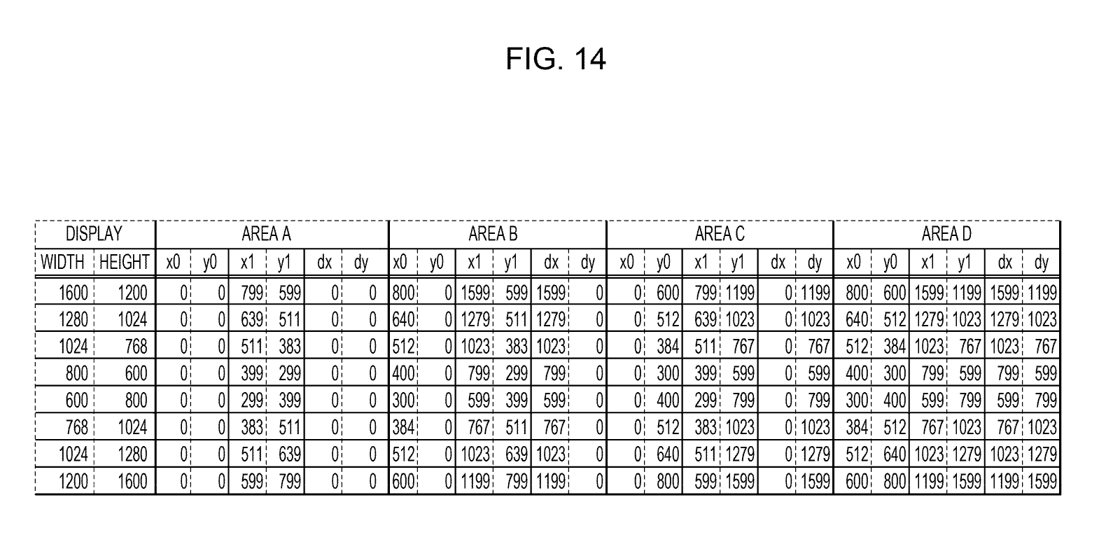

According to the previously described embodiments, the determination regarding in which area the object is located at S302 when calculating the first reference point at S509 is determined when any of the previously described Expressions 1-4 are satisfied, but the present disclosure is not limited thusly. For example, the area determination may be performed based on the number of pixels in the display area of the display as illustrated in FIG. 14 and correspondence table of the coordinates in each area. Specifically, the x₀, y₀, x₁, y₁ in each area regarding the current number of pixels in the display area are referenced regarding the object coordinates (x, y), and when the following Expression 15 is true, the values dx, dy may be obtained to indicate that the object is present in this area. In this case, the area and the area reference points may be set freely.

x₀≦x≦x₁ and y₀≦y≦y₁ Expression 15

According to the previously described embodiments, the display area is divided, and the area reference point of the area in which the object is located is designated as the first reference point, but the present disclosure is not limited thusly. For example, multiple reference points may be set in the display area, and the reference point closest to the object may be designated as the first reference point. In this case, the display area does not have to be divided into multiple areas, and the object coordinates may be decided by a method similar to that regarding the first through fourth embodiments.

According to the second embodiment, the process to decide the object is performed using the vertical size and the horizontal size of the display area as represented by Expressions 9-12, but the present disclosure is not limited thusly. Instead of the vertical size and the horizontal size of the display area, for example, the size between two of the reference points set in the display area may be used.

According to the previously described embodiments, processing results are temporarily stored in the RAM 103 at S503, S511, S1302, and S1307, but the these results may also be stored in the hard disk 105.

The previously described embodiments have been described using a case in which all of the display area of the display 106 is an area capable of displaying objects, but the present disclosure is not limited thusly. For example, the present disclosure may be applied to a case when a task bar of a predetermined width is set on one side of the display area, regardless of change in the display area. When setting a task bar of a predetermined width on one side of the display area, for example, the aspect ratio of the height/width of the display area changes with a rotation of the display area. The object may be arranged in a desired position in the display area in this case by still calculating the relative coordinates for the object coordinates based on the first reference point and the object display position, and then deciding the object arrangement based on the calculated relative position and the second reference point.

According to the present embodiments, objects may be arranged in suitable positions even when the display area is rotated.

### OTHER EMBODIMENTS

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application No. 2012-288232, filed Dec. 28, 2012, which is hereby incorporated by reference herein in its entirety.

What is claimed is:

1. A device comprising:
a detecting unit configured to detect rotation of a display area on a display device that displays objects;
a first deciding unit configured to decide a first reference point from a plurality of reference points set in the display area depending on the display position of the object displayed in the display area;
a specifying unit configured to specify relative positions of the object based on the display position of the object and the first reference point decided by the first deciding unit;
a second deciding unit configured to decide the position to arrange the object in the display area after rotation based on the relative position of the object as specified by the specifying unit and a second reference point corresponding to the first reference point from the plurality of reference points set on the display area after rotation in a case where a rotation of the display area is detected by the detecting unit; and
a control unit configured to cause a display unit to arrange the object at the position decided by the second deciding unit.

2. The device according to claim 1,
wherein, the first deciding unit decides, as the first reference point, a reference point set in a divided area in which the object is displayed, from among a plurality of divided areas into which the display area has been divided.

3. The display control device according to claim 1,
wherein the display position of the object is determined in accordance with an object reference point set for the object.

4. The device according to claim 1,
wherein the specifying unit determines the relative position of the object based on a distance between the first reference point and the display position of the object.

5. The device according to claim 4,
wherein the specifying unit specifies the relative position of the object based on the ratio in the distance between the first reference point in the display area and the display position of the object.

6. The device according to claim 1, further comprising:
a movement detection unit configured to detect movement of the object in the display area based on a received instruction,
wherein the first deciding unit re-decides the first reference point in a case where the movement is detected by the movement detection unit.

7. The device according to claim 1,
wherein the detecting unit detects changes in the resolution of the display area and rotations of the display area,
and wherein, in a case where both a rotation of the display area and a change in the resolution of the display area are detected by the detecting unit, the second deciding unit decides the position to arrange the object in the display area after rotation and a change in resolution, based on the relative position of the object as specified by the specifying unit and the second reference point corresponding to the first reference point from the plurality of reference points set in the display area after rotation and a change in resolution.

8. A method comprising:
detecting rotation of a display area on a display device that displays objects;
deciding a first reference point from a plurality of reference points set in the display area depending on the display position of the object displayed in the display area;
specifying relative positions of the object based on the display position of the object and the first reference point;
determining the position to arrange the object in the display area after rotation based on the specified relative position of the object and a second reference point corresponding to the first reference point from the plurality of reference points set on the display area after rotation in a case where a rotation of the display area is decided; and
causing a display unit to arrange the object at the decided position.

9. The method according to claim 8,
wherein, a reference point set in a divided area in which the object is displayed, from among a plurality of divided areas into which the display area has been divided, is decided as the first reference point.

10. The method according to claim 8,
wherein the display position of the object is determined in accordance with the object reference point set for the object.

11. The method according to claim 8,
wherein the relative position of the object is determined based on a distance between the first reference point and the display position of the object.

12. The method according to claim 11,
wherein the relative position of the object is specified based on the ratio in distance between the first reference point in the display area and the display position of the object.

13. The method according to claim 8, further comprising:
detecting movement of the object in the display area based on a received instruction;
wherein the first reference point is re-decided in a case where the movement is detected.

14. The method according to claim 8,
wherein, in the detecting the rotation, changes in the resolution of the display area and rotations of the display area are detected,
and wherein, in a case where both a rotation of the display area and a change in the resolution of the display area are detected, the position to arrange the object in the display area after rotation and a change in resolution are decided based on the specified relative position of the object and the second reference point corresponding to the first reference point from the plurality of reference points set in the display area after rotation and a change in resolution.

15. A non-transitory computer-readable recording medium, storing a program causing a computer to execute the method according to claim 8.
